(19) United States
(12) Patent Application Publication
(10) Pub. No.: US 2010/0175791 A1
(43) Pub. Date: Jul. 15, 2010

(54) FLUX FOR BRAZING METAL MATERIALS

(76) Inventor: Dominique Gomes, Chartreux (FR)

Correspondence Address: Horst M. Kasper, 13 Forest Drive, Warren, NJ, 07059, US

(21) Appl. No.: 12/223,270

(22) PCT Filed: Jan. 24, 2007
(86) PCT No.: PCT/EP2007/050691

§ 371 Date: Sep. 8, 2008

(30) Foreign Application Priority Data
Jan. 26, 2006 (DE) 10 2006 003 921.1

(51) Int. Cl. B23K 35/36

(52) U.S. Cl. 148/26

(57) ABSTRACT

Boric acid-free fluxes based on inorganic boron compounds for brazing metallic materials in combination with silver, copper or nickel base solders are known. Starting from this, in order to provide a further flux for brazing that is free of boric acid and contributes to a good wetting of the workpieces to be joined and that is distinguished by residues of low corrosivity, it is suggested according to the invention that the boron compounds should comprise potassium pentaborate and potassium metaborate, the ratio of the weight parts of potassium pentaborate and potassium metaborate being in the range between 4 and 10.

The present invention relates to a boric acid-free flux based on inorganic boron compounds for brazing metallic materials in combination with silver, copper or nickel base solders.

Soldering is a method for the integral joining of metallic materials with the help of a molten additional metal called solder. The melting temperature of the solder material is below the melting temperature of the material of the workpieces to be joined. Subject to metallic fine surfaces, the liquid solder wets the basic material. Therefore, oxide layers, as are found on any technical metal surface, must first of all be removed, which is accomplished in the case of soldering in air by the soldering point being covered with fluxes. In the melt of the flux, existing oxides are decomposed at the soldering temperature, or they are dissolved.

Hence, the flux has the primary function to remove existing oxides on the soldering and upper surfaces and to prevent the formation thereof during the soldering process, so that the solder is able to adequately wet the basic material.

Alloys based on silver, copper (also brass or bronze) or nickel, or pure metals, are used for brazing. The melting temperature of the flux must be adapted to the working temperature of the brazing solder. As a rule, the flux fuses at about 50° C. to 100° C. below the working temperature of the brazing solder. The molten flux is to form a dense uniform coating on the workpiece, said coating being maintained during soldering for the duration of the soldering period. Liquidus temperatures of more than 450° C. refer to brazing processes.

The fluxes are normally non-metallic compounds, such as acids, salts or resins. Since the fluxes often show an etching action, there is the risk that flux residues at the soldering point have a corrosion-promoting effect. Therefore, fluxes are ideally pH neutral at room temperature and develop their etching action only at the soldering temperature.

Brazing fluxes normally consist of salt mixtures that are capable of dissolving metal oxides. These are predominantly inorganic boron compounds, particularly alkali borates and fluoroborates or halides, particularly alkali fluorides.

DE 28 02 1987 C2, for instance, discloses a flux mixture consisting of 60% potassium pentaborate, 35% potassium tetrafluoroborate, and 5% potassium hydrogen fluoride which is mixed into a paste with 2% ethylene-propylene mixed polymer and processed into a shaped part of flux. As a rule, however, the fluxes are present as powders, suspensions, or in paste form.

DE 24 44 521 A1 discloses a flux for brazing that consists of boric acid and various alkali metal polyborates. In addition, the flux may contain 1% by wt. of boron in elemental form. Boric acid has an effect on the human hormone system and is therefore considered to be extremely harmful to health.

GB 909 314 A discloses a brazing flux for soldering nickel and nickel alloys, which flux, in addition to components such as potassium tetrafluoroborate, potassium metaborate and potassium fluoride, also contains copper compounds, such as copper oxide or copper chloride, the last-mentioned components being meant to suppress the reaction of the flux with the basic material so as to avoid embrittlement.

GB 782,307 A discloses a silver solder alloy and a flux suited therefor, the flux containing potassium pentaborate, potassium tetraborate, potassium bifluoride and potassium fluoroborate. Said flux has a melting point of 1100° F., whereas the silver solder is said to have a melting temperature of 1200° F.

Due to its toxicity, fluxes do preferably not contain boric acid. The industrial standard DIN EN 1045 (printed in 1997) classifies the fluxes for brazing heavy metals according to their composition and effective temperature into seven types, of which six types contain boron compounds and one type is free from boron, but contains chlorides and fluorides.

When some of said known fluxes are used, corrosive residues are formed that must be removed after soldering in a complicated manner.

It is the object of the present invention to provide a further flux for brazing that is free from boric acid and contributes to a good wetting of the workpieces to be joined and is distinguished by residues of low corrosivity.

Starting from the above-indicated brazing flux, said object is achieved according to the invention in that the boron compounds comprise potassium pentaborate and potassium metaborate, the ratio of the weight parts of potassium pentaborate and potassium metaborate being in the range between 4 and 10.

Potassium pentaborate (KB₅O₈ or KB₅O₈.5H₂O) is a standard flux component. This is however not true for potassium metaborate (KBO₂).

Surprisingly enough, it has been found that a multipurpose flux can be obtained from the two components, said flux attaining a good wetting behavior of the solder on the material to be soldered. This is above all noticed in metallic materials and hard materials that are otherwise difficult to wet. A precondition for this is that the ratio of the weight parts of potassium pentaborate and potassium metaborate is in the range between 4 and 10.

Further advantages of the flux of the invention are that the two above-mentioned boron compounds are substances of comparatively low toxicity and that it forms residues of comparatively low corrosivity.

As for the wetting properties, it has turned out to be particularly advantageous when the ratio of the weight parts of potassium pentaborate and potassium metaborate is in the range between 5 and 8, preferably in the range between 6.5 and 7.

With respect to a good wetting of the material to be soldered and with respect to a flux residue showing a corrosivity that is as low as possible, the flux according to the invention ideally consists exclusively of boron compounds, except for a possible liquid portion. In practice, fluxes have turned out to be useful in the case of which the boron compounds, apart from a liquid portion, account for at least 90% by wt., preferably at least 95% by wt., of the flux.

The brazing flux of the invention is substantially based on the two indicated components potassium pentaborate and potassium metaborate, additions of other substances being here possible as long as the above-indicated advantageous properties of the two indicated boron compounds with the indicated quantitative ratio are not deteriorated thereby to a substantial degree. Further borates of potassium and alkaline-earth metals are predominantly qualified as supplementary boron compounds; also, the standard halogen compounds, such as fluorides and chlorides of alkali and alkaline-earth metals.

However, in this context it has turned out to be useful when the two components potassium pentaborate and potassium metaborate account for at least 90% by wt., preferably at least 95% by wt., of the boron compounds.

An embodiment of the flux of the invention in which the boron compounds are exclusively present in the form of potassium pentaborate and potassium metaborate is particularly preferred. This leads to particularly low amounts of corrosive residues.

In this context it has turned out to be particularly advantageous when the weight part of potassium pentaborate, based on the total portion of boron compounds, is between 75% and 94%.

Thus, the weight part of potassium metaborate, based on the total portion of the boron compounds, is preferably between 6% and 25%.

Particularly on account of the desired low toxicity of the flux according to the invention, said flux does preferably not contain borax (NaB₄O₅(OH)₄.H₂O).

In this context and also for the purpose of a low corrosivity of the residue, an embodiment of the flux according to the invention has also turned out to be advantageous that does not contain fluorine compounds and/or chlorine compounds.

The flux according to the invention is present as a shaped part, powder, suspension or paste, and it can also be combined with the solder material, for example as a powder mixture. In a flux which is present in paste form, the liquid portion is between 15% by wt. and 30% by wt., preferably between 20% by wt. and 26% by wt.

The liquid portion (this is normally water, aliphatic alcohols, glycols or the like) is set in response to the desired viscosity of the flux.

The invention shall now be explained in more detail with reference to an embodiment.

### EXAMPLE 1

A flux for brazing in combination with a solder material consisting of 40 Cu, 25 Ag, 32 Zn and 2 Sn (concentrations indicated in parts by weight) is prepared with the following composition:
65.0% by wt. of potassium pentaborate
10.5% by wt. of potassium metaborate
24.5% by wt. of water

The components potassium pentaborate and potassium metaborate are used in powder form, weighed out and supplied together with water to a continuously operating mill and finely ground therein and homogenized. Said grinding and homogenizing process is repeated three times, resulting in a homogeneous paste that is distinguished by the above-indicated water content and by a typical grain size of the used flux powder of less than 100 μm.

The weight ratio of the two components potassium pentaborate and potassium metaborate is 6.19. The flux is free from borax, boric acid, chlorides and fluorides and is used for joining components of brass by brazing, and in combination with the above-indicated hard solder material it is distinguished by a good wetting of the components to be joined and by low corrosivity.

### EXAMPLE 2

A flux for brazing in combination with a brass brazing solder consisting of 58 Cu, 1 Ag, the balance being Zn (concentrations indicated in parts by weight), is prepared with the following composition:
69.0% by wt. of potassium pentaborate
9.5% by wt. of potassium metaborate
21.5% by wt. of water

The components potassium pentaborate and potassium metaborate are used in powder form, weighed out and supplied together with water to a continuously operating mill and finely ground therein and homogenized, as described above with reference to Example 1.

This yields a homogeneous paste that is distinguished by the above-indicated water content and by a typical grain size of the used flux powder of less than 100 μm.

The weight ratio of the two components potassium pentaborate and potassium metaborate is 7.26. The flux is free from borax, boric acid, chlorides and fluorides and is used for joining components of steel by brazing, and in combination with the above-indicated solder material it is distinguished by a good wetting of the components to be joined and by low corrosivity.

### EXAMPLE 3

A flux for brazing in combination with a solder material consisting of 60 Cu and 40 Zn (concentrations indicated in parts by weight) is prepared with the following composition:
67.0% by wt. of potassium pentaborate
10.0% by wt. of potassium metaborate
23.0% by wt. of water

The components potassium pentaborate and potassium metaborate are used in powder form, weighed out and supplied together with water to a continuously operating mill and finely ground therein and homogenized, as described above with reference to Example 1.

This yields a homogeneous paste that is distinguished by the above-indicated water content and by a typical grain size of the used flux powder of less than 100 μm.

The weight ratio of the two components potassium pentaborate and potassium metaborate is 6.7. The flux is free from borax, boric acid, chlorides and fluorides and is used for joining components of steel by brazing, and in combination with the above-indicated solder material it is distinguished by a good wetting of the material of the components to be joined and by low corrosivity.

1. A boric acid-free flux based on inorganic boron compounds for brazing metallic materials in combination with silver, copper or nickel base solders, characterized
in that the boron compounds comprise potassium pentaborate and potassium metaborate, the ratio of the weight parts of potassium pentaborate and potassium metaborate being in the range between 4 and 10.

2. The flux according to claim 1, characterized in that the ratio of the weight parts of potassium pentaborate and potassium metaborate is in the range between 5 and 8, preferably in the range between 6.5 and 7.

3. The flux according to claim 1, characterized in that
the boron compounds, apart from a liquid part, account for at least 90% by wt., preferably at least 95% by wt., of the flux.

4. The flux according to claim 1, characterized in that potassium pentaborate and potassium metaborate account for at least 90% by wt.,
preferably at least 95% by wt., of the boron compounds.

5. The flux according to claim 1, characterized in that
the boron compounds are exclusively present in the form of potassium pentaborate and potassium metaborate.

6. The flux according to claim 1 characterized in that it does not contain borax.

7. The flux according to claim 1, characterized in that it does not contain fluorine compounds.

8. The flux according to claim 1, characterized in that it does not contain chlorine compounds.

9. The flux according to claim 1, characterized in that
the weight part of potassium pentaborate, based on the total portion of the boron compounds, is between 75% and 94%.

10. The flux according to claim 1, characterized in that the weight part of potassium metaborate, based on the total portion of the boron compounds, is between 6% and 25%.

11. The flux according to claim 1, characterized in that, while being present in paste form, it has a liquid portion between 15% by wt. and 30% by wt., preferably between 20% by wt. and 26% by wt.
